(19) United States
(12) Patent Application Publication
(10) Pub. No.: US 2004/0155783 A1
(43) Pub. Date: Aug. 12, 2004

(54) Automatic confined space monitoring and alert system

(76) Inventor: Zaher Al-Sheikh, Sterling Heights, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/749,494

(22) Filed: Dec. 31, 2003

Related U.S. Application Data
(60) Provisional application No. 60/438,032, filed on Jan. 3, 2003.

(51) Int. Cl. G08B 23/00

(52) U.S. Cl. 340/584; 340/573.1; 340/457

(57) ABSTRACT

A confined space monitoring system includes a mammalian body detector sensing a confined space. A thermocouple measures the temperature within the space relative to a thermal threshold. When the temperature in the space is beyond the thermal threshold and an occupant is detected within the space, an alarm subsystem communicates to a remote location the situation. In the instance of a vehicle confined space, when the temperature remains above the threshold for a predetermined amount of time, with the occupant within the vehicle, or in the instance of a building structure, when an auditory alarm triggered by the temperature exceeding the thermal threshold not being reset within a preselected amount of time. A video camera is optionally included to communicate to a remote location that an occupant is indeed present within the confined space.

### RELATED APPLICATION

This application claims priority of U.S. Provisional application serial. No. 60/438,032 filed on Jan. 3, 2003, the contents of which are incorporated herein by reference.

### FIELD OF THE INVENTION

The present invention relates generally to a system for detecting a vehicle or structure occupant and in particular to a system for automatically releasing an occupant trapped and remotely notifying an owner of the occurrence.

### BACKGROUND OF THE INVENTION

Death and thermal distress are unfortunately too common when small children or pets are left unattended in a stationary vehicle. The most common scenario by which a stranded vehicle occupant suffers death or thermal stress is the vehicle driver leaving the vehicle to perform an errand. This problem is particularly acute in warm weather when the passenger compartment of a vehicle parked in a lot can rapidly increase to dangerous levels, especially for small children that tend to be prone to dehydration.

Prior art systems have been developed that activate an auditory alarm upon the detection of an occupant in a stationary vehicle surpassing a thermal threshold. Such systems have met with limited success owing to the desensitization of the public to the cacophony of car alarms currently in use.

Still other prior art systems, upon passenger compartment temperature reaching a preselected threshold and the detection of an occupant therein, cause a window to open to thereby reduce the temperature therein. However, such a system still fails to signal the neglectful driver and may actually provide a misinformed driver with a sense of security that leaving an occupant unattended in a vehicle is somehow acceptable. Thus, there exists a need for a vehicle occupant release system that assures the safety of the trapped occupant and also notices the neglectful driver or another responsible party of the situation.

In the structure setting, such as a home, concerns of thermal distress with respect to the elderly also exist as well as fears about burglary. These problems are compounded in the structure setting since there is little likelihood of passerby intervention. Also, an individual may imperceptibly become incapacitated by the effects of thermal distress and not notice there is a problem until it is too late to act and request help.

Thus, there exists a need for a system that monitors a confined space for the presence of a mammalian body and an alarm subsystem automatically relaying to a remote location mammalian body information.

### SUMMARY OF THE INVENTION

A confined space monitoring system includes a mammalian body detector sensing a confined space. A thermocouple measures the temperature within the space relative to a thermal threshold. When the temperature in the space is beyond the thermal threshold and an occupant is detected within the space, an alarm subsystem communicates to a remote location the situation. In the instance of a vehicle confined space, when the temperature remains above the threshold for a predetermined amount of time, with the occupant within the vehicle, or in the instance of a building structure, when an auditory alarm triggered by the temperature exceeding the thermal threshold not being reset within a preselected amount of time. A video camera is optionally included to communicate to a remote location that an occupant is indeed present within the confined space.

In an instance where the confined space is a vehicle compartment, a switch automatically opens a vehicle portal in response to the temperature exceeding the thermal threshold and the detector sensing an occupant within the vehicle compartment. Preferably, when a message is communicated to a remote location indicating the vehicle compartment temperature is beyond the thermal range, such a message also communicates vehicle location information.

A wireless communication receiver for receiving a message from a system alarm subsystem includes a housing containing a wireless antenna for receiving an emergency signal from an alarm subsystem. A display is provided within the receiver for converting the emergency signal into a human recognizable form. A digital display is incorporated within the receiver for storing images recallable on the display. A data transmission portal and a battery power supply render the receiver amenable to communicate with other devices and portable, respectively.

A process for releasing an occupant trapped within a confined space is detailed to include a mammalian body detector in the space and sensing the temperature within that space. A comparison of the temperature within the space with a preselected threshold temperature causes activation of a wireless transmitter alarm subsystem in response to the temperature exceeding the preselected threshold or the failure of an auditory alarm to be reset while an occupant is detected within the space.

### BRIEF DESCRIPTION OF THE DRAWINGS

FIG. 1 is a schematic block diagram of a vehicle confined space system according to the present invention;

FIG. 2 is a schematic block diagram of a structure confined space system according to the present invention; and

FIG. 3 is a cross sectional view of an emergency message receiver and digital image storage device fashioned as a key fob.

### DETAILED DESCRIPTION OF THE PREFERRED EMBODIMENTS

The present invention has utility as a mammalian inhabitant monitoring system for a confined space such as a vehicle or a dwelling. An alarm subsystem is present to transmit to a remote location a preselected alarm condition. The alarm information is preferably communication to a pocket display fashioned as a key fob or other useful article likely to be conveyed by a user.

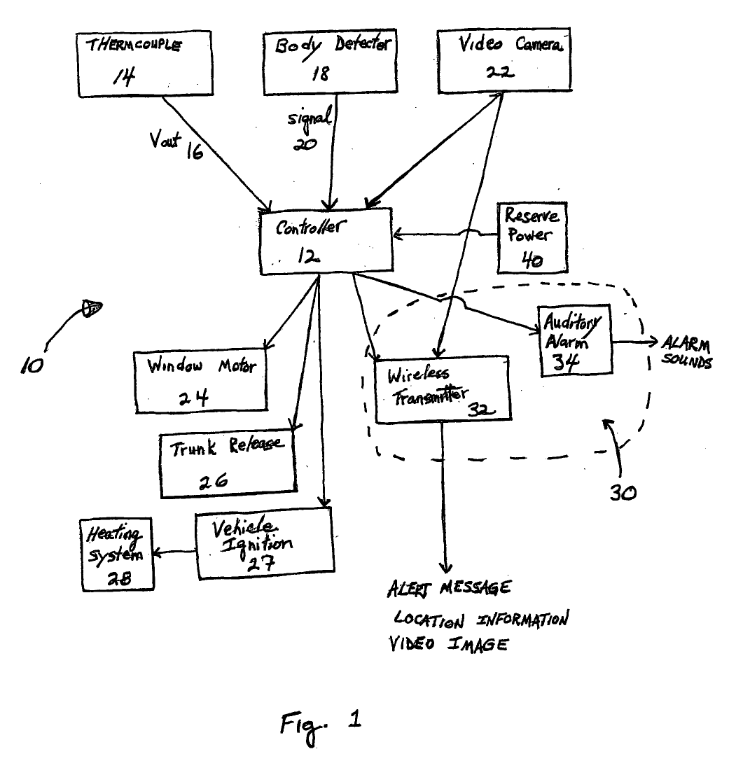

FIG. 1 is a schematic illustration of a trapped vehicle occupant system 10 in accordance with one embodiment of the present invention. The inventive system includes a controller 12 receiving inputs from a thermocouple 14 measuring the temperature within a vehicle compartment. As used herein, vehicle compartment is defined to include a passenger compartment and a trunk. The thermocouple output voltage 16 is fed to a controller 12 and compared to a threshold voltage corresponding to a predetermined temperature threshold. While vehicle compartment overheating is most often the situation the present invention intends to avoid, it is appreciated that a low temperature threshold is also optionally set. The controller 12 compares the voltage output 16 from the thermocouple 14 relative to a preselected threshold value. A mammalian body detector 18 is positioned to sense the movement associated with a human or animal occupant within the vehicle compartment. Preferably, the motion detector 18 is configured to transmit an electrical signal to the controller 12. Motion detectors conventional to the art are operative herein and illustratively include those that operate on the principles of an infrared sensor, vibration sensors, carbon dioxide sensors and the like. Optionally, a video camera 22 is also mounted to capture an image of the passenger compartment. The video camera, if present, preferably has a fisheye or other wide-angle lens system capable of capturing a wide view of the compartment. A video camera 22 is particularly well suited for use in a passenger compartment. The output from the video camera 22, if present, is likewise fed to controller 12.

The controller 12 upon receiving an output voltage 16 from the thermocouple 14 corresponding to a temperature outside of a preselected range, as well as a signal 20 from the motion detector 18 indicating the presence of either a human or animal occupant within the passenger compartment, thereby triggers the controller 12 to acquire a video image if the system is equipped with a video camera 22. The controller 12 activates a switch (not shown) that automatically opens a vehicle portal. A vehicle portal as used herein is defined to include a window, sunroof, door, and trunk lid. Preferably, the vehicle portal opened in response to an extreme temperature in the presence of an occupant is a window and as such the controller 12 engages a switch to drive a window motor 24. However, it is appreciated that a sunroof, vent fan or other process by which cooler outside air can be delivered to the passenger compartment. In the case of an occupant being confined within a trunk, activation of a trunk release 26 is sufficient to rescue a trapped occupant. Conversely, when the temperature falls below a preselected threshold, a switch (not shown) automatically starts the vehicle ignition 27 and the activation of the vehicle passenger compartment heating system 28. In this way, the passenger compartment of a vehicle is maintained at a warmer and therefore safer temperature without compromising the ability to later start the vehicle. Preferably, the ignition switch of the system 10 has a cycling mode such that a motorist trapped for instance in a blizzard can stay within the vehicle for a significant period of time and even sleep without fear of hypothermia.

The controller 12 has an alert subsystem 30. The alarm subsystem 30 preferably includes a wireless transmitter 32 capable of transmitting an emergency message to a remote location. More preferably, the wireless transmitter 32 is a cellular communication transmitter preprogrammed with contact phone numbers. Preferably, the transmitter communicates not only a an emergency alert toa remote location, but also the thermocpuple read temperature. The transmitter 32 sequentially dialing preselected contact phone numbers until a message is received. Thereafter, the transmitter waits a predetermined amount of time, for instance two to ten minutes, before accessing another contact telephone number. Typical contact numbers include likely vehicle driver cellular telephone numbers, other vehicle owner contact numbers, and emergency service personnel. Still more preferably, in embodiments of the present invention having a video camera 22, a video image, in either still or movie format, is sent by the wireless transmitter 32 to a recipient contact number capable of visualizing the image to assure that the notification is not a false alarm. The wireless transmitter 32 remains active and serves as a beacon emergency personnel can use to triangulate to locate the vehicle. Optionally, the wireless transmitter 32 also includes a speakerphone (not shown) so that an emergency alert recipient can communicate to an occupant to gage their responsiveness and to communicate rescue information. Alternatively, the vehicle is equipped with a global positioning satellite system (not shown) capable of transmitting by wireless transmitter 32 the vehicle location. A conventional auditory alarm 34 alone or in combination with the wireless transmitter 32 also functions as an alarm system 30. The auditory alarm 34 utilizing the vehicle horn or a devoted auditory siren. It is appreciated that power to operate an inventive system 10 is derived from the vehicle electrical system. Preferably, the inventive system 10 has a reserve power unit 40 to enable the controller 12 to function in the event that the vehicle battery loses power. The reserve power unit 40 preferably includes rechargeable batteries or capacitors that can be recharged through the vehicle electrical system or periodically replaced as part of scheduled maintenance.

In a preferred embodiment, the system 10 has a remote activator (not shown) initiated by a telephone call and the entry of a password. The remote activator operative as an anti-theft device to transmit vehicle location and optionally an occupant image from a system including a video camera. In a still more preferred embodiment, an inventive system includes an alarm set switch whereby vehicle motion such as movement onto a trailer bed initiates transmitter activation to dial contact telephone numbers and the transmission of vehicle compartment images if a video camera is present in an inventive system.

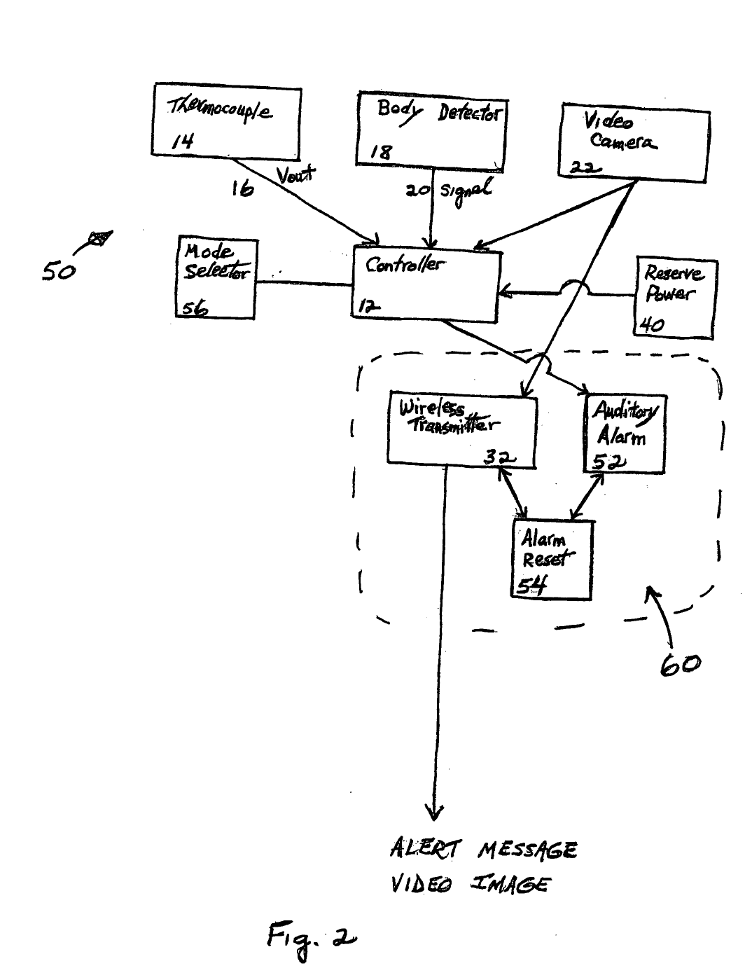

FIG. 2 is a schematic illustration of a structure monitoring and alert system 40 in accordance with one embodiment of the present invention where like numerals relative to FIG. 1 have the meanings attached thereto. The inventive system 50 includes a controller 12 receiving inputs from a thermocouple 14 measuring the temperature within a structure room. Where one room of a structure, such as a bedroom is equipped with an additional temperature moderating device such as a room air conditioner, that room of the structure is monitored as the refuge an occupant would use in extreme temperature conditions. The thermocouple output voltage 16 is fed to a controller 12 and compared to a threshold voltage corresponding to a predetermined temperature threshold. While occupant overheating is most often the situation the present invention intends to avoid, it is appreciated that a low temperature threshold is also optionally set. The controller 12 compares the voltage output 16 from the thermocouple 14 relative to a preselected threshold value. A mammalian body detector 18 is positioned to sense the movement associated with a human or animal occupant within the room. Preferably, the motion detector 18 is configured to transmit an electrical signal to the controller 12. Motion detectors conventional to the art are operative herein and illustratively include those that operate on the principles of an infrared sensor, vibration sensors, carbon dioxide sensors and the like. Optionally, a video camera 22 is also mounted to capture an image of the room. As a matter of privacy, the video camera is only activated to collect an image when a preselected thermal threshold value is exceeded. The output from the video camera 22, if present, is likewise fed to controller 12.

The controller 12 upon receiving an output voltage 16 from the thermocouple 14 corresponding to a temperature outside of a preselected range, as well as a signal 20 from the motion detector 18 indicating the presence of either a human or animal occupant within the room. An auditory alarm 52 is triggered within the structure to alert a human occupant that a potentially dangerous thermal distress situation has been reached. In most instances, an individual will take steps to moderate the structure temperature or evacuate the structure. In the event that the alarm reset 54 is not engaged within a preselected time period, the controller 12 activates the wireless transmitter 32 and acquires a video image if the system is so equipped with a video camera 22. Typical reset times for the alarm are 5 to 30 minutes.

Optionally, the system 50 includes a mode selector 56 interfaced with the controller 12. The selector 56 allows the body detector 18 to function in a trigger mode where any detection of a mammalian body activates the alarm subsystem. In this mode, the system 50 is operative as a burglar alarm with a remote notification capability. Preferably, where a mode selector 56 is present a user keypad is included to allow for entering of a personal identification number as a mode selector control and activator. In burglar alarm mode, the auditory alarm is appreciated to be activated or alternatively, remain silent and the transmission to a remote location being the only indicator of triggering.

The controller 12 has an alert subsystem 60 that is activated by the auditory alarm reset 54 not being activated during the preselected time in thermal distress mode or the detection of body movement in burglar alarm mode. The alarm subsystem 60 includes a wireless transmitter 32 capable of transmitting an emergency message to a remote location. Preferably, the transmitter 32 also transmits the temperature derived from the thermocouple reading as part of the emergency alert message when the alarm subsystem is in thermal distress mode. Still more preferably, in embodiments of the present invention having a video camera 22, a video image, in still or movie format, is sent by the wireless transmitter 32 to a recipient contact number capable of visualizing the image to assure that the notification is not a false alarm. The wireless transmitter 32 optionally need not remains active, since a transmitter number identifier indicates the structure address. However, the wireless transmitter 32 may stay active when it optionally includes a speakerphone (not shown) so that an emergency alert recipient can communicate to an occupant to gage their responsiveness and to communicate rescue information. The auditory alarm 34 utilizes a devoted auditory siren. It is appreciated that power to operate an inventive system 50 is derived from the structure line power electrical system. Preferably, the inventive system 50 has a reserve power unit 40 to enable the controller 12 to function in the event that the structure loses line power. The reserve power unit 40 preferably includes rechargeable batteries or capacitors that can be recharged through the line power system or periodically replaced as part of scheduled maintenance.

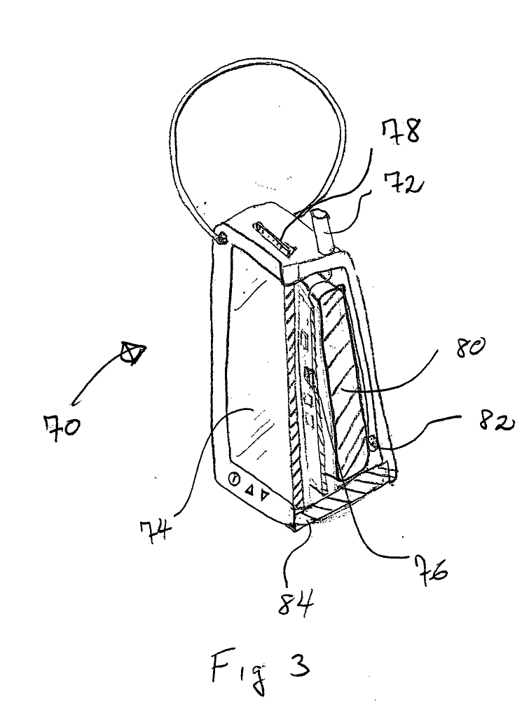

An emergency message, alone or in concert with a video image, is readily communicated to a conventional receiver remote from the inventive system. Conventional receivers for receipt of an emergency message include telephones; wireless devices such as cellular telephones, pagers, and PDAs; facsimile machines; and computers. In the preferred embodiment, the emergency message receiver is a wireless communication device shown generally at 70 in FIG. 3. The receiver 70 contains a reception antenna 72. The reception antenna 72 being conventional to the art such as a quarter-wave or half-wave nonlinear antenna. A display 74 allows for an emergency text message alone, or in combination with a video image, a video camera 22 to be displayed on the receiver 70. Preferably, the receiver 70 includes an internal memory 76 for the storage of digital images therein. More preferably, the receiver 70 has a data transmission port 78 to facilitate image exchange between the receiver 70 and other devices. As such, the receiver 70 will not in use as a receiver of emergency messages from an inventive system operates as a digital miniature photo album. Most preferably, the receiver 70 is formatted to be portable. Integration of the receiver 70 as a key fob further facilitates the portable aspects of the most preferred embodiment thereof. A rechargeable battery source 80 coupled to a recharging portal 82 further enhances the portable aspects of the most preferred embodiment. Preferably, the receiver 70 is part of the conventional circuitry for receiving a wireless communication and converting the same into text or image formatted for display 72 also includes an auditory alarm 82 having a low battery notification tone and an emergency message receipt tone.

Optionally, the receiver 70 includes a magnetic stripe, linear barcode, or two-dimensional barcode that has the ability to receive manufacturers' coupons downloaded therein or coded information read from the receiver housing 84 in order to access manufacturers' coupons from a central database or from a stored database. In so doing, the receiver 70 operates to retrieve a coupon from the database or discount certain items automatically during a store checkout process. The ability of the receiver 70 to receive directed wireless communication is optionally also utilized to store monetary or service credits that are replenished by wireless communication. Service credits illustratively include telephone usages credits, and merchant specific credits. The credits can be used from the receiver 70 by way of the data transmission port 78.

Modifications and variations of the present invention are possible in light of the above teachings. Therefore, it is to be understood that within the scope of the appended claims the invention may be practiced in ways other than as specifically described. In view of the teachings presented herein, such modifications and variations to the present invention will be readily apparent to one skilled in the art. The foregoing drawings, discussion and description are illustrative of some embodiments of the present invention, but are not meant to be limitations on the practice thereof. The following claims and equivalents thereof are intended to define the scope of the invention.

1. A confined space monitoring system comprising:
a mammalian body detector sensing a confined space;
a thermocouple measuring a temperature within the confined space relative to a thermal threshold; and
an alarm subsystem communicating to a remote location that the temperature in the space is beyond the thermal threshold and an occupant is within the space subsequent to a condition precedent.

2. The system of claim 1 wherein the confined space is selected from the group consisting of: a building structure, a vehicle passenger compartment, and a vehicle trunk.

3. The system of claim 1 wherein the alarm subsystem is a wireless transmitter.

4. The system of claim 3 wherein the wireless transmitter is a cellular communication transmitter.

5. The system of claim 3 wherein said alarm subsystem comprises an auditory alarm indicating that the temperature in the space exceeds a thermal threshold and the occupant is within the space.

6. The system of claim 1 wherein the condition precedent is the temperature within a vehicle confined space being above the threshold for a predetermined amount of time with the occupant therein.

7. The system of claim 5 wherein the condition precedent is failure to reset the auditory alarm within a preselected amount of time.

8. The system of claim 1 wherein said alarm subsystem has a burglar detection mode that communicates an emergency signal to a remote location upon detecting the occupant within the space and independent of the temperature being beyond the thermal threshold.

9. The system of claim 8 further comprising a video camera activated to collect an image as part of the emergency signal.

10. The system of claim 1 further comprising a video camera.

11. The system of claim 5 wherein said video camera is activated upon the temperature within the confined space exceeding the thermal threshold and the occupant is within the space.

12. The system of claim 5 wherein a video image is transmitted remotely by the alarm subsystem.

13. The system of claim 1 wherein said mammalian body detector comprises a type of sensor selected from the group consisting of: infrared, vibration, and carbon dioxide.

14. The system of claim 3 further comprising a wireless receiver, said receiver comprising:
a housing;
a wireless antennae for receiving an emergency signal from said alarm subsystem;
a display for providing the emergency signal in human recognizable form;
a digital memory for storing images;
a data transmission portal; and
a receiver battery power supply.

15. The system of claim 14 wherein the receiver housing has an aperture engaging a key ring.

16. The system of claim 14 wherein the housing includes a coding label selected from the group consisting of: a bar code, a one dimensional bar code, and a two dimensional bar code.

17. The system of claim 1 further comprising location information communicated to the remote location by said alarm subsystem.

18. The system of claim 16 further comprising a global positioning satellite system providing the geographic location information when the confined space is within a vehicle.

19. A confined space monitoring system comprising:
a mammalian body detector sensing a vehicle compartment;
a thermocouple measuring a temperature within the vehicle compartment relative to a thermal threshold;
a switch automatically opening a vehicle portal in response to the temperature within the vehicle compartment exceeding the thermal threshold and said detector sensing an occupant within the vehicle compartment; and
an alarm subsystem automatically communicating to a remote location that the temperature in the vehicle compartment is beyond the thermal threshold and the occupant is within the vehicle compartment.

20. The system of claim 18 wherein the alarm subsystem comprises a wireless transmitter.

21. The system of claim 19 further comprising an auditory alarm indicating that said switch has been activated.

22. The system of claim 18 further comprising a video camera.

23. The system of claim 21 wherein said video camera is activated upon the temperature within the vehicle compartment exceeding the thermal threshold and the occupant is within the vehicle compartment.

24. The system of claim 21 wherein a video image is transmitted remotely by the alarm subsystem.

25. The system of claim 18 wherein the vehicle portal is selected from the group consisting of a window, sunroof, and trunk.

26. The system of claim 18 further comprising vehicle location information communicated to the remote location by said alarm subsystem.

27. The system of claim 25 further comprising a global positioning satellite system providing the geographic location information.

28. The system of claim 19 wherein the cellular communication transmitter transmits a signal suitable for triangulation to locate the vehicle compartment.

29. A wireless communication receiver comprising:
a housing;
a wireless antennae for receiving an emergency signal from an alarm subsystem of claim 1;
a display for providing the emergency signal in human recognizable form;
a digital memory for storing images recallable on said display;
a data transmission portal; and
a receiver battery power supply.

30. The system of claim 29 wherein the receiver housing has an aperture engaging a key ring.

31. The system of claim 29 wherein the housing includes a coding label selected from the group consisting of: a bar code, a one dimensional bar code, and a two dimensional bar code.

32. A process for releasing a trapped occupant from a confined space comprising the steps of:
disposing a mammalian body detector in the space;
sensing a temperature within the space;
comparing the temperature with a preselected threshold temperature; and
activating a wireless transmitter alarm subsystem in response to a condition precedent of a failure to reset an auditory alarm or the temperature remaining above the threshold with the occupant present for a preselected amount of time.

33. The process of claim 31 further comprising the step of:
opening a portal in the space when the occupant is detected within the space and the temperature therein is beyond the threshold for the preselected amount of time.

34. The process of claim 33 wherein the wireless transmitter further communicates a location for the space.

35. The process of claim 33 wherein said wireless transmitter operates as a location triangulation beacon.

36. The process of claim 33 further comprising the step of disposing a video camera in the space and transmitting a video image by way of said wireless transmitter.
